(19) United States
(12) Patent Application Publication
(10) Pub. No.: US 2026/0339013 A1
(43) Pub. Date: Oct. 29, 2026

(54) LIGHT-GUIDING ELEMENT, LIGHT-GUIDING MODULE, AND ELECTRONIC DEVICE

(71) Applicant: JTK TECHNOLOGY CORP., Taoyuan City (TW)

(72) Inventors: Jauh-jung YANG, Taoyuan City (TW); Ting-wei HSU, Taoyuan City (TW); Yu-hsien LIN, Taoyuan City (TW)

(21) Appl. No.: 19/415,833

(22) Filed: Dec. 11, 2025

(30) Foreign Application Priority Data
Dec. 20, 2024 (TW) 113214113

(51) Int. Cl. F21V 8/00

(52) U.S. Cl. CPC G02B 6/0018; G02B 6/0065; G02B 6/0068; G02B 6/0073

(57) ABSTRACT

A light-guiding element, a light-guiding module and an electronic device are provided in the present application. The light-guiding element includes an incident light section, a mixing light section, a light modulation section, and an emitting section. After a light enters an incident side of the incident light section, the light is reflected by two or more incident reflective surfaces of the incident light section and guided to the mixing light section. The light is then reflected by two or more mixing reflective surfaces of the mixing light section and guided to the light modulation section. The light modulation surface directs the light into the emitting section, and the light emits from an emitting surface of the emitting section. By incorporating the light-guiding element, the light-guiding module and the electronic device can efficiently utilize a light source, enhance light emitting efficiency, and provide a uniform light emission.

### CROSS REFERENCE TO RELATED APPLICATIONS

This application claims priority to Taiwan Application Serial No. 113214113, filed on Dec. 20, 2024, the disclosure of which is incorporated herein by reference.

### FIELD OF APPLICATION

The present application relates to a field of display technology, and more particularly relates to a light-guiding element, a light-guiding module, and an electronic device.

### BACKGROUND

A light-guiding element, such as a light guide plate, is utilized to transmit light emitted from an LED over a predetermined distance through total internal reflection, while maintaining the optical efficiency and directionality of the light. Generally speaking, the light-guiding element provides display and indication functions, for example, directing the light emitted from the LED toward an external surface of a product to visually present various status information or serve as an indicator. Additionally, the light-guiding element provides backlight and illumination functions, for example, serving as a backlight for LCD screens or illuminating patterns on transmissive windows, thereby enabling uniform and efficient lighting. Moreover, the light-guiding element enhances the visual appearance of the product by serving a decorative function.

Conventional designs of light-guiding elements exhibit multiple drawbacks. First, arranging a small number of LEDs may cause hot spot issues. Second, increasing the number of LEDs to eliminate the hot spots results in increased cost and weight.

Accordingly, in view of the disadvantages associated with conventional light-guiding elements, there is a need to design a novel light-guiding element to overcome these drawbacks.

### SUMMARY OF APPLICATION

One objective of the present application is to provide a light-guiding element capable of efficiently utilizing a light source, increasing light emitting efficiency, and achieving a uniform optical output effect.

Another objective of the present application is to provide a light-guiding module capable of achieving uniform light output with a reduced number of LEDs, thereby lowering costs.

A further objective of the present application is to provide an electronic device featuring excellent display performance and reduced cost.

Additional objectives and advantages of the present application can be further understood from the technical features disclosed herein. To achieve the above objectives, the technical approach adopted in the present application provides a light-guiding element.

In a first aspect, the present application provides a light-guiding element including an incident light section, a mixing light section, a light modulation section and an emitting section.

The incident light section includes an incident side and two or more incident reflective surfaces. The two or more incident reflective surfaces are arranged around the incident side. The mixing light section is connected to the incident light section and includes two or more mixing reflective surfaces. The two or more mixing reflective surfaces are connected to the two or more incident reflective surfaces correspondingly. The light modulation section is connected to the mixing light section and includes a light modulation surface. The emitting section is connected to the light modulation section and includes an emitting surface. The emitting surface is configured to face the light modulation surface. After a light enters the incident side, the two or more incident reflective surfaces reflect the light toward the mixing light section, the two or more mixing reflective surfaces reflect the light toward the light modulation section, the light modulation surface directs the light into the emitting section, and the light emits from the emitting surface.

Optionally, the light-guiding element further includes a reflective layer arranged on the two or more mixing reflective surfaces and the light modulation surface by an adhesive coating process or a dual-shot molding process.

Optionally, a material of the reflective layer is selected from metal, plastic, or ceramic.

Optionally, the incident light section further includes a plurality of incident cavities disposed on the incident side and spaced apart from each other. Each of the plurality of incident cavities is arranged toward an interior of the light-guiding element in a recessed manner to define an incident surface with a curved concave or convex shape. A spacing between two adjacent ones of the plurality of incident cavities is defined as an incident pitch, a distance between the incident side and the emitting surface is defined as a light-guiding distance, and a ratio of the incident pitch to the light-guiding distance is greater than 0.5.

Optionally, the incident side is selected from a planar surface, a curved surface, a combination of planar and curved surfaces, or a surface provided with an optical microstructure, and each of the two or more incident reflective surfaces is selected from a planar surface, a curved surface, a combination of planar and curved surfaces, and a surface provided with an optical microstructure.

Optionally, the mixing light section includes at least one corner portion disposed at a position distal away from the incident light section, and the light modulation section is connected to the at least one corner portion. The mixing light section guides the light toward the light modulation section via the at least one corner portion.

Optionally, the mixing light section further includes at least one of a straight portion and a curved portion and the mixing light section is disposed between the incident light section and the at least one corner portion.

Optionally, at least one light-mixing microstructure region is provided on the two or more mixing reflective surfaces of the mixing light section, and the at least one light-mixing microstructure region is selected from at least one of a micro-prism array, a lenticular lens array, a microlens array, and a texture.

Optionally, the emitting section is vertically arranged and perpendicular to a horizontal reference plane, and an angle between the light modulation surface and the horizontal reference plane is less than 60 degrees.

Optionally, the light modulation section further includes a light modulation structure disposed on the light modulation surface.

Optionally, the light modulation structure is arranged with a uniform density or a non-uniform density.

Optionally, the emitting section includes two emitting reflective surfaces respectively located at two sides of the emitting surface, each of the two emitting reflective surfaces is a planar surface, a curved surface, or a combination of planar and curved surfaces. The emitting surface is a planar surface or a textured surface, and a light transmissive material is coated on the emitting surface.

Optionally, the emitting section includes two emitting reflective surfaces respectively located at two sides of the emitting surface, and each of the two emitting reflective surfaces is a wavy curved surface extending along a length direction of the light-guiding element.

Optionally, the emitting section includes two end portions and an intermediate portion along a length direction of the light-guiding element, and a width of each of the two end portions is less than or equal to a width of the intermediate portion.

Optionally, along a length direction of the light-guiding element, the light-guiding element is a linear plate-like element or a curved plate-like element including one or more bending structures.

Optionally, the light-guiding element is made of a transparent material with a refractive index greater than 1, the material is selected from polycarbonate, polymethyl methacrylate, silicone, glass, and the like.

In a second aspect, the present application provides a light-guiding module including a light source and the light-guiding element.

The light source is configured to provide a light.

The light-guiding element includes the incident light section, the mixing light section, the light modulation section and the emitting section. The incident light section includes the incident side and the two or more incident reflective surfaces. The two or more incident reflective surfaces are arranged around the incident side. The mixing light section is connected to the incident light section and includes the two or more mixing reflective surfaces. The two or more mixing reflective surfaces are connected to the two or more incident reflective surfaces correspondingly. The light modulation section is connected to the mixing light section and includes the light modulation surface. The emitting section is connected to the light modulation section and includes the emitting surface. The emitting surface is configured to face the light modulation surface.

The light provided by the light source enters the incident side, the two or more incident reflective surfaces reflect the light toward the mixing light section, the two or more mixing reflective surfaces reflect the light toward the light modulation section, the light modulation surface directs the light into the emitting section, and the light emits from the emitting surface.

Optionally, the light source is an LED light board including at least one set of LED light-emitting components, and the at least one set of LED light-emitting components is front-emitting and controlled by a circuit.

Optionally, the incident light section further includes a plurality of incident cavities spaced apart from each other, each of the plurality of incident cavities is arranged toward an interior of the light-guiding element in a recessed manner to define an incident surface with a curved concave or convex shape, and LEDs of the at least one set of LED light-emitting components are accommodated within corresponding ones of the plurality of incident cavities and faces toward the incident surface.

In a third aspect, the present application provides an electronic device including a housing and any one of the foregoing light-guiding modules.

The housing includes a display region. The light-guiding module is mounted within the housing. The light-guiding element includes the incident light section, the mixing light section, the light modulation section and the emitting section. The incident light section includes the incident side and the two or more incident reflective surfaces. The two or more incident reflective surfaces are arranged around the incident side. The mixing light section is connected to the incident light section and includes the two or more mixing reflective surfaces. The two or more mixing reflective surfaces are connected to the two or more incident reflective surfaces correspondingly. The light modulation section is connected to the mixing light section and includes the light modulation surface. The emitting section is connected to the light modulation section and includes the emitting surface. The emitting surface is configured to face the light modulation surface and is located in the display region.

The light provided by the light source enters the incident side, the two or more incident reflective surfaces reflect the light toward the mixing light section, the two or more mixing reflective surfaces reflect the light toward the light modulation section, the light modulation surface directs the light into the emitting section, and the light emits from the emitting surface.

The display region is a strip-shaped opening, and the emitting surface of the emitting section is exposed through the display region, and the light source of the light-guiding module is disposed within the housing and is located within a conical field of view deviating by 30 degrees from a vertical centerline of the display region.

Compared with conventional technologies, the light-guiding element of the present application enables efficient utilization of the light source, improves light emitting efficiency, and achieves a uniform optical emission effect through incorporating the mixing light section and the light modulation section. Additionally, the presence of the reflective layer further enhances light emitting efficiency. The light-guiding module and the electronic device of the present application, by incorporating the light-guiding element, enable uniform light emission in the display region with a minimal number of LEDs, reduce product cost, and provide excellent optical display performance in the display region of the electronic device, effectively serving as a decorative or indicative feature.

### BRIEF DESCRIPTION OF DRAWINGS

FIG. 1 is a perspective view of a light-guiding element according to an embodiment of the present application.

FIG. 2 is a side view of the light-guiding element shown in FIG. 1.

FIG. 3 is a partially enlarged perspective view of a portion A shown in FIG. 1, mainly illustrating detailed structures of a mixing light section.

FIG. 4 is another perspective view of a light-guiding element according to an embodiment of the present application.

FIG. 5 is a partially enlarged perspective view of a portion B shown in FIG. 4, mainly illustrating detailed structures of a light modulation surface.

FIGS. 6a, 6b, and 6c are side views of the light-guiding element, mainly showing a relative positional relationship between the light modulation surface and a horizontal reference plane.

FIG. 7a is a perspective view of a light-guiding element according to another embodiment of the present application.

FIG. 7b is a partially enlarged perspective view of a portion C shown in FIG. 7a, mainly showing a wavy curved surface of the emitting reflective surface.

FIG. 8a is a perspective view of a light-guiding element according to another embodiment of the present application.

FIG. 8b is a partially enlarged perspective view of a portion D shown in FIG. 8a, mainly showing another design of the emitting reflective surface.

FIG. 9a is a perspective view of a light-guiding element according to another embodiment of the present application.

FIG. 9b is a top plane view of the light-guiding element shown in FIG. 9a.

FIG. 10a is a perspective view of a light-guiding element according to a further embodiment of the present application.

FIG. 10b is a top plane view of the light-guiding element shown in FIG. 10a.

FIG. 11 is a perspective view of a light-guiding module according to one embodiment of the present application.

FIG. 12 is a partial perspective view of a partial structure of an electronic device according to one embodiment of the present application, mainly showing a relative positional relationship between a housing and the light-guiding module.

FIG. 13 is a perspective view illustrating another angle of a partial structure of the electronic device, mainly showing a contour of a display region.

FIG. 14 is a side view of a partial structure of the electronic device according to the present application, mainly showing a field of view (FOV) of the display region.

### DETAILED DESCRIPTION

The following description of the embodiments refers to the accompanying drawings to illustrate specific examples in which the present application may be implemented. In the description of the embodiments, terms such as “upper,” “lower,” “front,” “rear,” “left,” “right,” “inner,” and “outer” refer to directions or positional relationships based on the orientations shown in the drawings, and are provided solely for convenience in describing the present application and for simplifying the explanation. These terms do not indicate or imply that the referred devices or components must be constructed or operated in a particular orientation, and should not be interpreted as limitations on the present application.

In the description of the embodiments of the present application, terms such as “first” and “second” are used only to clearly identify different parts or components, or to distinguish between similar elements, so that the technical structure and the functions of respective parts can be accurately understood. These terms should not be interpreted as indicating any particular order or level of importance.

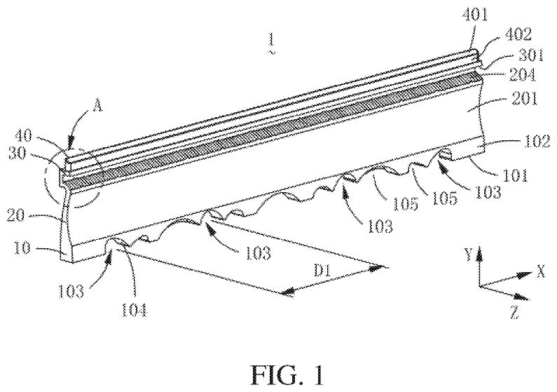

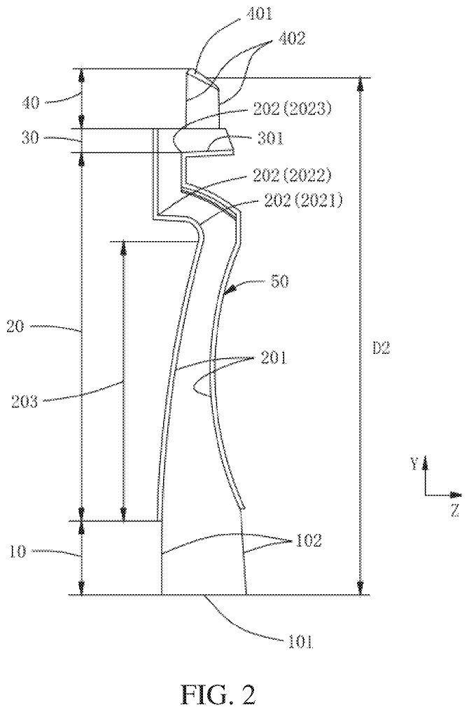

Referring to FIG. 1 and FIG. 2, a light-guiding element 1 according to an embodiment of the present application includes an incident light section 10, a mixing light section 20, a light modulation section 30, and an emitting section 40. The incident light section 10 includes an incident side 101 and two incident reflective surfaces 102 disposed around the incident side 101. In a side view shown in FIG. 2, the two incident reflective surfaces 102 are located on two sides of the incident side 101. The mixing light section 20 is connected to the incident light section 10 and includes two mixing reflective surfaces 201 respectively connected to the two incident reflective surfaces 102. The light modulation section 30 is connected to the mixing light section 20 and includes a light modulation surface 301. The emitting section 40 is connected to the light modulation section 30 and includes an emitting surface 401 facing the light modulation surface 301. After a light enters the incident side 101, the two incident reflective surfaces 102 reflect the light toward the mixing light section 20. The two mixing reflective surfaces 201 reflect the light toward the light modulation section 30. The light modulation surface 301 directs the light into the emitting section 40, and then the light is emitted from the emitting surface 401.

Specifically, as shown in FIG. 1 and FIG. 2, the light-guiding element 1 defines a height direction Y, a length direction X, and a width direction Z. The incident light section 10, the mixing light section 20, the light modulation section 30, and the emitting section 40 are sequentially arranged along the height direction Y.

It should be noted that, for the purpose of illustration, guide lines are used in FIG. 2 to roughly distinguish the sections (the incident light section 10, the mixing light section 20, the light modulation section 30, and the emitting section 40). However, the scope of these sections should not be construed as being limited by the areas defined by the guide lines. The boundaries of the sections may vary accordingly based on the structural variations of the light-guiding element 1.

The light-guiding element 1 of the present application further includes a reflective layer 50, as indicated in FIG. 2. The reflective layer 50 is formed on at least the two mixing reflective surfaces 201 and the light modulation surface 301 through a process such as an adhesive coating process or a dual-shot molding process. In other embodiments, except for the emitting surface 401 and an incident surface 104 to be described later, the reflective layer 50 may cover other surfaces of the light-guiding element 1, excluding the emitting surface 401 and the incident surface 104, which will be described later. For example, the reflective layer 50 may also be disposed on the two incident reflective surfaces 102. As will also be described later, the reflective layer 50 may further be disposed on the emitting reflective surfaces 402 of the emitting section 40. By incorporating the reflective layer 50, the light-guiding element 1 achieves improved light emitting efficiency.

The material of the reflective layer 50 may be selected from metal, plastic, or ceramic. These materials effectively ensure that light is reflected into the interior of the light-guiding element 1 with low energy loss, thereby improving light emitting efficiency.

The following provides a detailed description of the structure and function of the incident section 10 of the light-guiding element 1 in the present application.

The incident light section 10 may be formed with a planar structure, a curved structure, or optical microstructures to achieve light diffusion and mixing effects. The optical microstructures include, for example, a micro-prism array, a lenticular lens array, or a microlens array.

In this embodiment, as shown in FIG. 1, the incident side 101 is formed by a combination of multiple planar surfaces and multiple curved surfaces, and the incident reflective surface 102 is a planar surface. In practice, the incident side 101 of the light-guiding element 1 may be a planar surface, a curved surface, a combination of planar and curved surfaces, or a surface provided with optical microstructures. The incident reflective surface 102 of the incident section 10 may also be a planar surface, a curved surface, a combination of planar and curved surfaces, or a surface provided with optical microstructures. More specifically, the incident side 101 may be formed by one or more planar surfaces, one or more curved surfaces, a combination of one or more planar surfaces and one or more curved surfaces, or any surface provided with optical microstructures. The incident reflective surface 102 may likewise be formed by one or more planar surfaces, one or more curved surfaces, a combination of one or more planar surfaces and one or more curved surfaces, or any surface provided with optical microstructures.

Referring again to FIG. 1, the incident light section 10 includes a plurality of incident cavities 103 disposed on the incident side 101 and spaced apart from each other. Each of the plurality of incident cavities 103 is arranged toward an interior of the light-guiding element 1 in a recessed manner, namely recessed upward along the height direction Y of the light-guiding element 1, to define the incident surface 104 with a curved shape that is formed in a concave or convex manner. A spacing between two adjacent incident cavities 103 is defined as an incident pitch D1, and a distance between the incident side 101 and the emitting surface 401 (specifically a center of the emitting surface 401) is defined as a light-guiding distance D2. A ratio of the incident pitch D1 to the light-guiding distance D2 is greater than 0.5. Furthermore, in this embodiment, the incident pitch D1 refers to the spacing between two adjacent incident cavities 103 along the length direction X of the light-guiding element 1, and the light-guiding distance D2 refers to the distance the incident side 101 and the emitting surface 401 along the height direction Y of the light-guiding element 1. By designing the spacing between the incident cavities 103 to satisfy the ratio, the number of LEDs required in the light-guiding module 2 can be reduced, thereby lowering the overall cost.

As shown in FIG. 1, a plurality of recessed cavities 105 having identical or different dimensions are arranged between two adjacent ones of the plurality of incident cavities 103. Each of the plurality of recessed cavities 105 may have a size different from that of the incident cavities 103. The recessed cavities 105 are arranged toward the interior of the light-guiding element 1 in a recessed manner, thereby defining curved cavity walls that enhance light-gathering characteristics for light entering the incident surfaces 104, prevent light leakage, and provide an initial uniformity effect in terms of light intensity and color.

The structure and function of the mixing light section 20 of the light-guiding element 1 of the present application are described in detail below.

The primary function of the mixing light section 20 is to guide the light from the incident light section 10 by total internal reflection or the law of reflection. A light-mixing path of the mixing light section 20 includes at least one straight line, at least one arbitrary curve, or a combination of straight lines and curves, and then enters the light modulation section 30 through one or more corner portions.

Specifically, referring to the side view of the light-guiding element 1 shown in FIG. 2, the mixing light section 20 includes at least one corner portion 202 located at a position distal away from the incident light section 10. The light modulation section 30 is connected to the corner portion 202. The mixing light section 20 guides the light toward the light modulation section 30 by redirecting the light through the corner portion 202.

In this embodiment, as shown in FIG. 2, the mixing light section 20 includes multiple corner portions 202, such as a first corner portion 2021, a second corner portion 2022, and a third corner portion 2023 arranged in sequence. Each of the corner portions 202 includes a bent structure having an angle of approximately 90 degrees, allowing a light path that is generally a vertical curve to be redirected into the light modulation section 30 through three successive 90-degree turns at the first corner portion 2021, the second corner portion 2022, and the third corner portion 2023. After passing through the multiple corner portions 202, the light is not only sufficiently mixed, but also directed to a desired position via the corner design. For example, the light is directed toward the light modulation surface 301 and is then guided by the light modulation surface 301 toward the emitting surface 401.

Additionally, along the height direction Y of the light-guiding element 1, the light-mixing light section 20 further includes at least one of a straight portion and a curved portion. The straight portion or the curved portion is located between the incident light section 10 and the corner portion 202.

For example, as shown in FIG. 2, the mixing light section 20 of this embodiment includes a curved portion 203. The curved portion 203 refers to a region where the mixing reflective surface 201 of the mixing light section 20 exhibits a curved shape along the height direction Y. The lower end of the curved portion 203 is connected to the incident section 10, and the upper end is connected to the corner portion 202, such as the first corner portion 2021. In other embodiments, the mixing light section 20 may also include a straight portion (not shown), in which case the mixing reflective surface 201 is a planar surface, such as a vertical plane or an inclined plane.

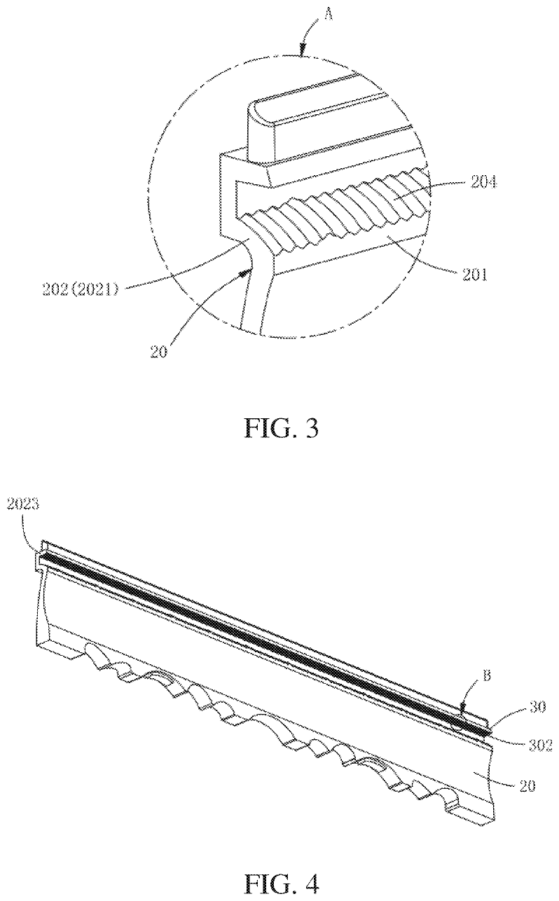

Referring to FIG. 1 and FIG. 3, a light-mixing microstructure region 204 is positioned on the two mixing reflective surfaces 201 of the mixing light section 20. In particular, the light-mixing microstructure region 204 is positioned one of the mixing reflective surfaces 201 at one of the multiple corner portions 202, such as the first corner portion 2021. The light-mixing microstructure region 204 may be, for example, a micro-prism array, a lenticular lens array, a microlens array, or a texture. In this embodiment, the light-mixing microstructure region 204 is implemented as a micro-prism array. The light-mixing microstructure 204 enables mixing of the light to achieve uniformity in color and light intensity.

It should be noted that, the present application does not limit the number, position, or area of the light-mixing microstructure region 204. The light-mixing microstructure region 204 may also be provided at other corner portions 202, such as the second corner portion 2022, and/or at other positions on the two mixing reflective surfaces 201. The area of the light-mixing microstructure region 204 may also be adjusted based on specific optical performance requirements.

The following provides a detailed description of the structure and function of the light modulation section 30 of the light-guiding element 1 of the present application.

The primary function of the light modulation section 30 is to receive light from the mixing light section 20 and to reflect the light toward the emitting section 40 through the light modulation surface 301.

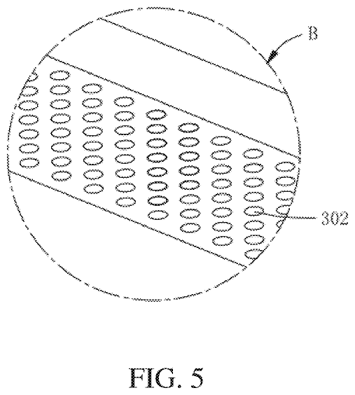

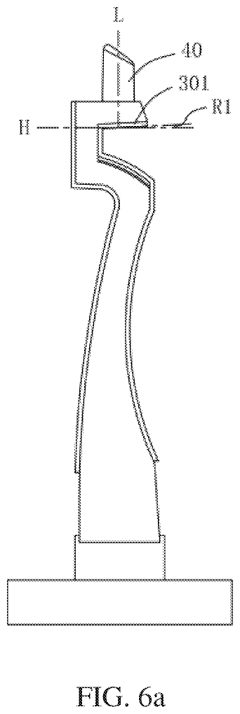

Referring to FIG. 4, the light modulation section 30 is connected to the third corner portion 2023 of the mixing light section 20. A light modulation structure 302 is positioned on the light modulation surface 301, such as a microlens array, a prism array, a texture, or a dot array. The function of the light modulation structure 302 is to interrupt total internal reflection within the light-guiding element 1, allowing the light to reach the reflective layer 50, which then reflects the light toward the emitting section 40. In this embodiment, the light modulation structure 302 is implemented as a dot array, as shown in FIG. 5.

Specifically, the light modulation structure 302 is arranged with a uniform density or non-uniform density to adjust the light emission across the entire area and achieve uniform illumination. For example, a higher-density dot array may be provided in darker emission regions of the light-guiding element 1, while a lower-density dot array may be provided in brighter emission regions. In this manner, light output uniformity can be adjusted by varying the density of the dot array.

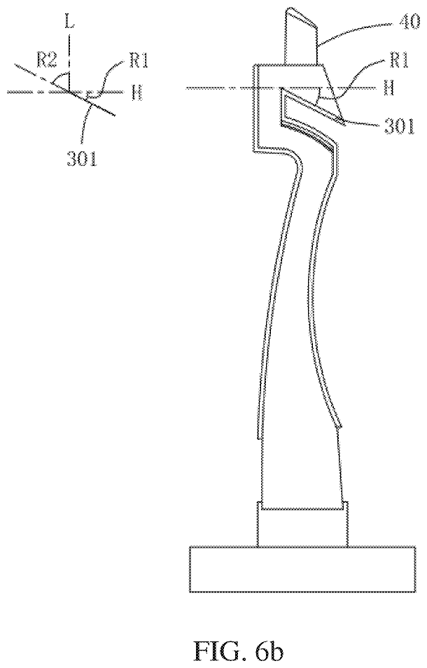

Additionally, as shown in FIG. 6a, FIG. 6b, and FIG. 6c, a deflection angle R1 between the light modulation surface 301 and a horizontal reference plane H is less than 60 degrees. In the present embodiment, as shown in FIG. 6a, the emitting section 40 is generally vertically arranged and perpendicular to the horizontal reference plane H, while the light modulation surface 301 forms a very small deflection angle R1 with respect to the horizontal reference plane H, nearly approaching 0 degree.

In other embodiments, the light modulation surface 301 may be deflected (or inclined) relative to the horizontal reference plane H in a counterclockwise or clockwise direction to appropriately increase the deflection angle R1. As long as the deflection angle R1 of the light modulation surface 301 is less than 60 degrees, the light can be reliably directed toward the emitting section 40. For example, FIG. 6b illustrates a design in which the light modulation surface 301 is deflected in a counterclockwise direction with the deflection angle R1 being less than 60 degrees, and FIG. 6c illustrates a design in which the light modulation surface 301 is deflected in a clockwise direction with the deflection angle R1 also being less than 60 degrees.

Alternatively, the configuration may also be described in this way, as long as an acute angle R2 between the light modulation surface 301 and a vertical centerline L of the emitting section 40 (as indicated in the schematic positional diagrams in FIGS. 6b and 6c) is greater than 30 degrees and less than 90 degrees, the light modulation surface 301 can reliably direct the light toward the emitting section 40. In the present embodiment, as shown in FIG. 6a, the acute angle R2 between the light modulation surface 301 and the vertical centerline L of the emitting section 40 is close to 90 degrees.

The following provides a detailed description of the structure and function of the emitting section 40 of the light-guiding element 1 of the present application.

The emitting section 40 includes at least one light-guiding path formed as a straight line or a curved line. The main function of the emitting section 40 is to receive the uniform light re-adjusted by the light modulation section 30, guide the light into the light-guiding path after reflection by the reflective layer 50, and finally emit the uniform light through the emitting surface 401 to the outside of the light-guiding element 1.

Referring to FIG. 2, in this embodiment, the emitting section 40 is connected to the light modulation section 30 and is positioned above the light modulation section 30. The emitting surface 401 may be arranged horizontally or inclinedly and faces toward the light modulation surface 301 to direct the light out of the light-guiding element 1. In this embodiment, the emitting surface 401 is a planar surface. Alternatively, the emitting surface 401 may also be a textured surface, and a light transmissive material may be coated on the emitting surface 401.

Additionally, the emitting section 40 includes two emitting reflective surfaces 402 respectively located on two sides of the emitting surface 401. The reflective layer 50 of the light-guiding element 1 in the present application may also be formed on the emitting reflective surfaces 402 to further improve the light emitting efficiency of the light-guiding element 1.

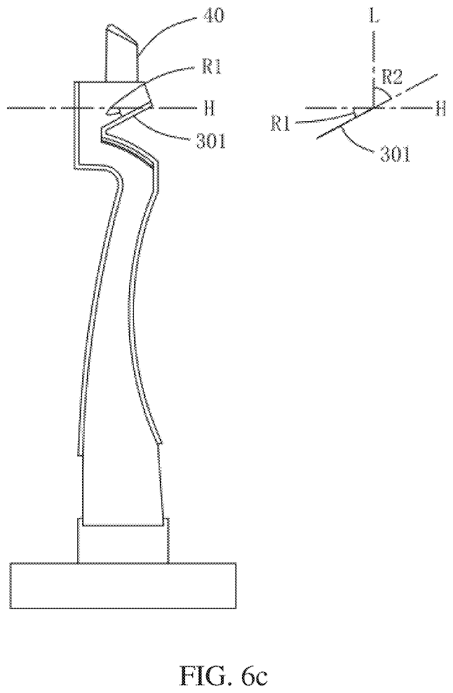

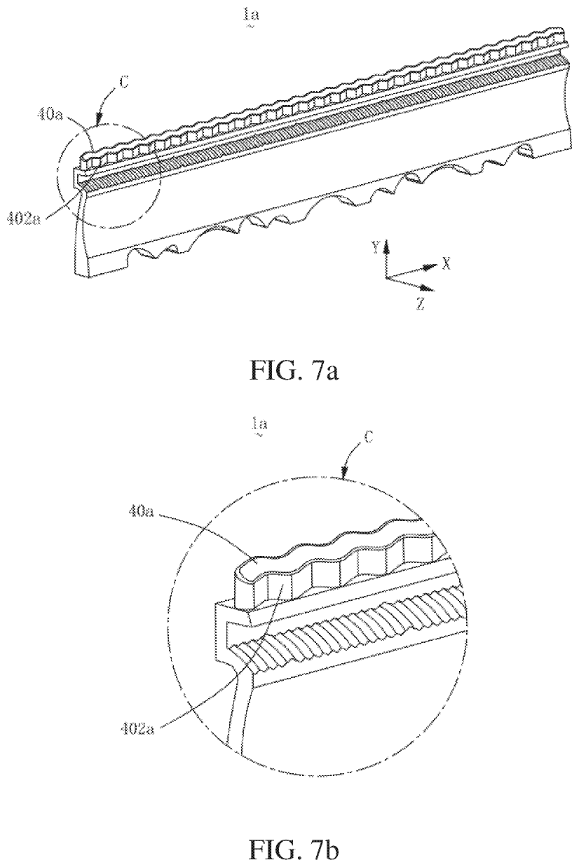

Each of the emitting reflective surfaces 402 may be a planar surface, a curved surface, or a combination of planar and curved surfaces. For example, FIG. 1 illustrates a design scheme in which the emitting reflective surfaces 402 are planar. FIGS. 7a and 7b show a light-guiding element la according to another embodiment. The emitting reflective surfaces 402a of the emitting section 40a are formed as wavy curved surfaces along the length direction X of the light-guiding element la. FIGS. 8a and 8b show a light-guiding element 1b according to another embodiment. The emitting section 40b includes two end portions 403 and an intermediate portion 404 arranged along the length direction. The width (or thickness) of the two end portions 403 is smaller than the width of the intermediate portion 404. In contrast, in the embodiments shown in FIG. 1 and FIG. 7a, the emitting sections 40 and 40a adopt a generally uniform width (or thickness). Accordingly, in the present application the width of the two end portions 403 may be configured to be less than or equal to the width of the intermediate portion 404.

In the above, components or structures in the embodiments shown in FIGS. 7a and 7b that are similar to those in the embodiment shown in FIG. 1 share the same reference numerals with an additional suffix “a.” Similarly, components or structures in the embodiments shown in FIGS. 8a and 8b that are similar to those in the embodiment shown in FIG. 1 share the same reference numerals with an additional suffix “b.”

The following provides a detailed description of the overall external shape of the light-guiding element 1.

In one embodiment, as shown in FIG. 1, along the length direction X of the light-guiding element 1, the overall external shape of the light-guiding element 1 is a straight linear plate-like element. Therefore, the light emitted from the emitting surface 401 forms a linear light strip. Along the height direction Y of the light-guiding element 1, the overall cross-sectional shape is generally upright or slightly inclined. For example, from the cross-sectional view shown in FIG. 2, the incident light section 10 is vertically arranged along the height direction Y, with the incident side 101 located at the bottom of the incident light section 10. One portion of the mixing light section 20 is approximately in a vertically curved or arcuate shape, while another portion is formed with multiple bends. The light modulation section 30 is generally in a horizontal orientation, and the emitting section 40 is vertically arranged.

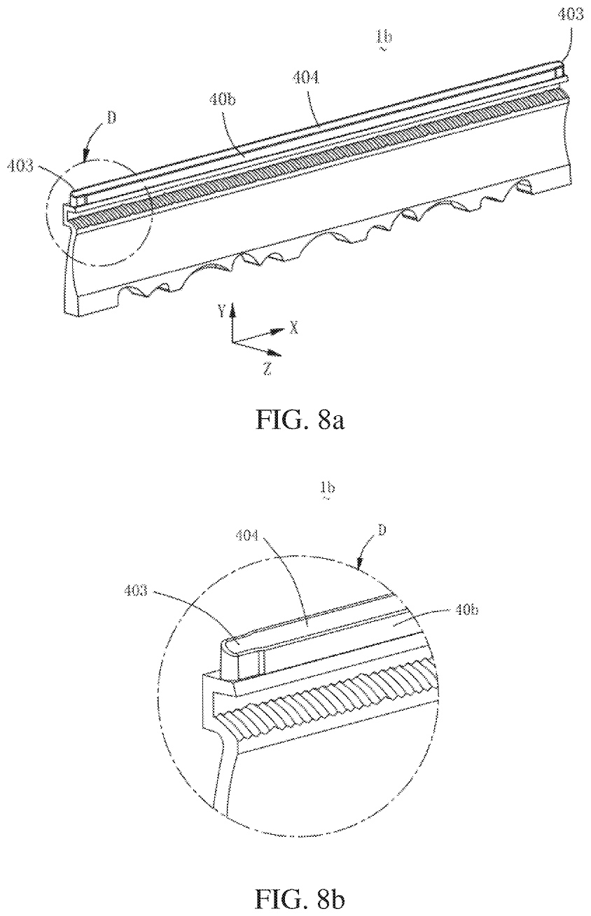

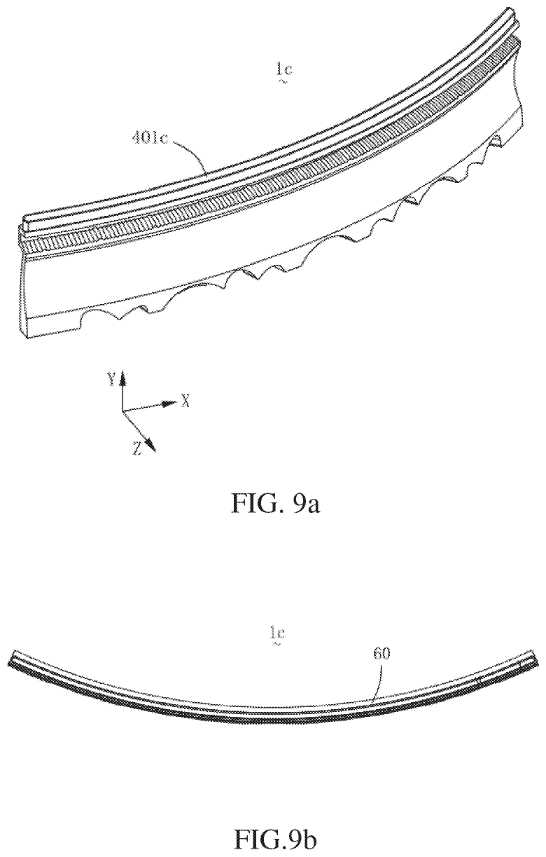

In other embodiments, the overall external shape of the light-guiding element 1 may also be a curved plate-like element including one or more bending structures 60. Specifically, in the embodiment shown in FIGS. 9a and 9b, along the length direction X of the light-guiding element 1c, the light-guiding element 1c includes a single bending structure 60. Accordingly, the light emitted from the emitting surface 401c forms a single curved light strip. In the embodiment shown in FIGS. 10a and 10b, along the length direction X of the light-guiding element 1d, the light-guiding element 1d includes multiple bending structures 60. Accordingly, the light emitted from the emitting surface 401d forms multiple curved light strips.

In the above, components or structures in the embodiments shown in FIGS. 9a and 9b that are similar to those in the embodiment shown in FIG. 1 share the same reference numerals with an additional suffix “c.” In the embodiments shown in FIGS. 10a and 10b, components or structures that are similar to those in the embodiment shown in FIG. 1 share the same reference numerals with an additional suffix “d.”

Accordingly, it can be inferred that the overall external shape of the light-guiding elements 1, 1a, 1b, 1c, and 1d may also be configured as plate-like elements enclosed in a quadrilateral, a circular shape, or other shapes. Accordingly, the emitting surfaces 401, 401c, and 401d can provide a quadrilateral, circular, or otherwise shaped light strip. Therefore, the present application does not limit the overall shape of the light-guiding elements 1, 1a, 1b, 1c, and 1d, and the shape may be varied based on the application scenario.

In addition, the cross-sectional shape of the light-guiding elements 1, 1a, 1b, 1c, and 1d along the height direction Y is not limited to an upright or nearly upright state but may instead be formed in a more inclined orientation according to the requirements of the application device.

Furthermore, the light-guiding elements 1, 1a, 1b, 1c, and 1d are made of a transparent material with high light transmittance and a refractive index greater than 1, such as polycarbonate (PC), polymethyl methacrylate (PMMA), silicone, glass, or other suitable transparent materials.

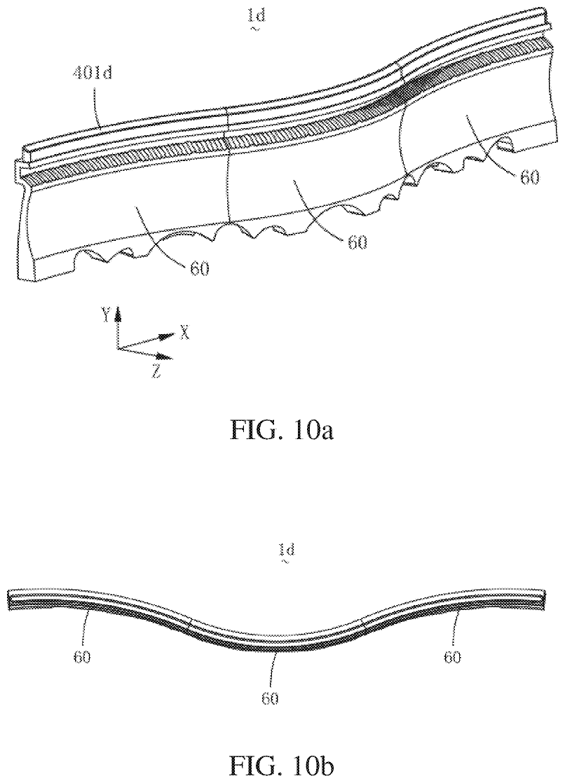

Referring to FIG. 11, the light-guiding module 2 of the present application includes a light source 70 and the previously described light-guiding element 1 (which may also be the light-guiding element 1a, 1b, 1c, or 1d). The light source 70 is configured to provide light. The light emitted from the light source 70 enters the light-guiding element 1 through the incident side 101, is reflected by the two incident reflective surfaces 102, and is guided into the mixing light section 20. After being mixed and homogenized by the mixing light section 20, the light is directed to the light modulation section 30, where the light modulation surface 301 re-adjusts the light and directs it into the emitting section 40. The light is then emitted from the emitting surface 401 to the outside of the light-guiding module 2.

As shown in FIG. 11, the light source 70 is an LED light board including at least one set of LED light-emitting components 701, each of the LED light-emitting components 701 is front-emitting and controlled by a circuit. In this embodiment, the light source 70 (i.e., the LED light board) includes multiple sets of LED light-emitting components 701. The LEDs in each set of the LED light-emitting components 701 can be individually controlled by the circuit to be turned on or gradually varied, thereby providing different lighting effects.

Specifically, the LEDs of each set of LED light-emitting components 701 are accommodated within corresponding incident cavities 103 of the light-guiding element 1 and faces the corresponding incident surface 104. Therefore, in this embodiment, the incident pitch D1 mentioned above (as indicated in FIG. 1) may refer to the spacing between two adjacent incident cavities 103, or to the spacing between two adjacent sets of LED light-emitting components 701. That is, the spacing between two adjacent sets of LED light-emitting components 701 is approximately equal to the spacing between two adjacent incident cavities 103. Similarly, the light-guiding distance D2 (as indicated in FIG. 2) in the present embodiment may refer to the distance between the incident side 101 and the emitting surface 401, or the distance between the LED light-emitting component 701 and the emitting surface 401. In other words, the distance between the LED light-emitting component 701 and the emitting surface 401 is approximately equal to the distance between the incident side 101 and the emitting surface 401.

Accordingly, the light-guiding module 2 satisfies the condition that the ratio of the incident pitch D1 to the light-guiding distance D2 is greater than 0.5, thereby reducing the number of LEDs required in the light-guiding module 2 and lowering costs.

It should also be noted that, the LED light board (i.e., the light source 70) in this embodiment may utilize LEDs of different colors, thereby enabling the emission of light in various colors, such as white, red (R), green (G), blue (B), and others. The LEDs are not limited to single-die packages or multi-die packages. The LEDs may be of the same model or of different models. These selections can be adjusted according to the desired lighting effect.

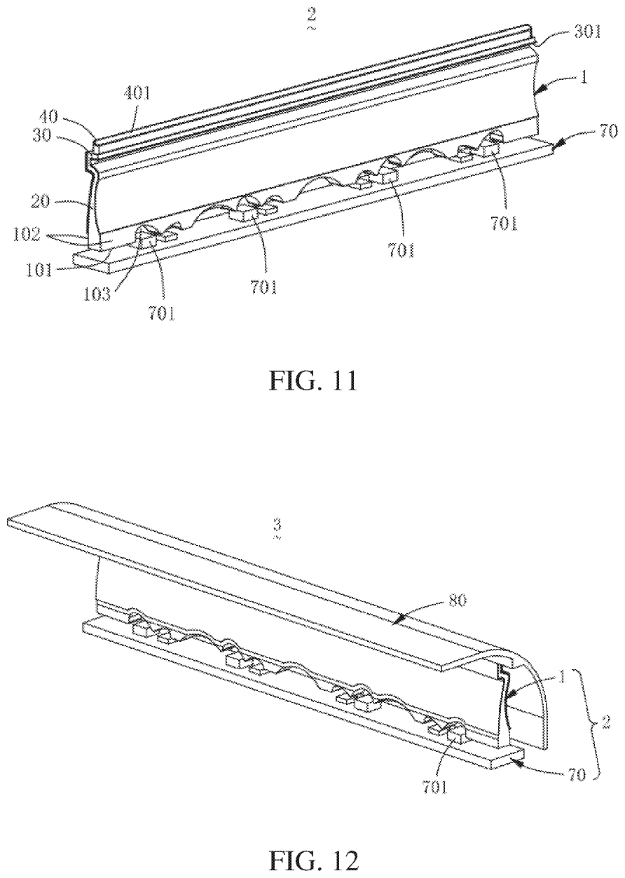

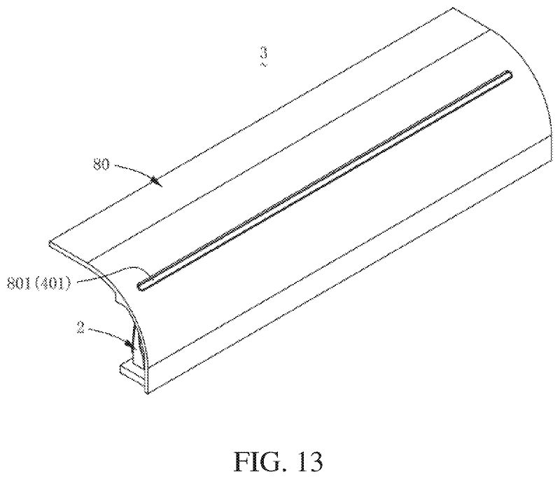

Referring to FIGS. 12 and 13, the above-described light-guiding module 2 is applied in an electronic device 3 of the present application. The electronic device 3 includes a housing 80 and the light-guiding module 2. The housing 80 includes a display region 801 exposed on an outer surface of the housing 80. The light-guiding module 2 is mounted within the housing 80, and the emitting surface 401 of the light-guiding element 1 is positioned in the display region 801.

Specifically, the display region 801 is a strip-shaped opening, and the emitting surface 401 of the emitting section 40 is exposed within the display region 801. When the LED light-emitting components 701 of the light source 70 emit light, the light is guided and modulated by the light-guiding element 1 to become uniform, and is then emitted from the emitting surface 401, thereby presenting an optical effect in the display region 801. This may serve decorative or indicative functions for the electronic device 3. Moreover, multiple sets of LED light-emitting components 701 can be controlled by the circuit to achieve color switching effects.

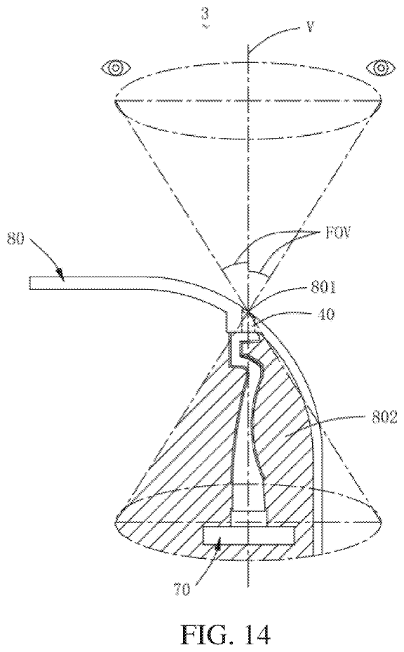

Referring to FIG. 14, to ensure that the display region 801 of the electronic device 3 achieves a certain field of view (FOV), the position of the light source 70 of the light-guiding module 2 within the housing 80 must be properly determined. In this embodiment, the light source 70 is disposed within an internal region 802 of the housing 80 that falls within a conical field of view (FOV) deviating by 30 degrees from a vertical centerline V of the display region 801. It should be noted that the conical field of view (FOV) is a three-dimensional spatial space, as shown in FIG. 14. Accordingly, the internal region 802 of the housing 80 where the light source 70 is positioned is not limited to a lateral position as illustrated in a cross-sectional view, but rather includes positions in the front, rear, left, and right directions.

In summary, the light-guiding module 2 and the electronic device 3 of the present application utilize the light-guiding element 1 with a specifically designed structure to achieve a uniform light output effect in the display region 801 under a condition of minimal number of LEDs. This design reduces product cost and enables the display region 801 of the electronic device 3 to exhibit excellent display performance, effectively serving decorative or indicative functions.

The foregoing provides a detailed description of the light-guiding element 1, the light-guiding module 2, and the electronic device 3 according to the embodiments of the present application. Specific examples have been used herein to illustrate the principles and implementation methods of the present application. The description of the above embodiments is intended only to facilitate understanding of the methods and core concepts of the present application. It should be understood that, various modifications in implementation and application scope may be made by those skilled in the art based on the ideas of the present application. Therefore, the content of this specification should not be construed as limiting the scope of the present application.

1. A light-guiding element, comprising:
an incident light section including an incident side and two or more incident reflective surfaces, wherein the two or more incident reflective surfaces are arranged around the incident side;
a mixing light section connected to the incident light section and including two or more mixing reflective surfaces, wherein the two or more mixing reflective surfaces are connected to the two or more incident reflective surfaces correspondingly;
a light modulation section connected to the mixing light section and including a light modulation surface; and
an emitting section connected to the light modulation section and including an emitting surface, wherein the emitting surface is configured to face the light modulation surface;
wherein, after a light enters the incident side, the two or more incident reflective surfaces reflect the light toward the mixing light section, the two or more mixing reflective surfaces reflect the light toward the light modulation section, the light modulation surface directs the light into the emitting section, and the light emits from the emitting surface.

2. The light-guiding element according to claim 1, further comprising a reflective layer arranged on the two or more mixing reflective surfaces and the light modulation surface by an adhesive coating process or a dual-shot molding process.

3. The light-guiding element according to claim 2, wherein a material of the reflective layer is selected from metal, plastic, or ceramic.

4. The light-guiding element according to claim 1, wherein the incident light section further includes a plurality of incident cavities disposed on the incident side and spaced apart from each other, and each of the plurality of incident cavities is arranged toward an interior of the light-guiding element in a recessed manner to define an incident surface with a curved shape;
wherein a spacing between two adjacent ones of the plurality of incident cavities is defined as an incident pitch, a distance between the incident side and the emitting surface is defined as a light-guiding distance, and a ratio of the incident pitch to the light-guiding distance is greater than 0.5.

5. The light-guiding element according to claim 1, wherein the incident side is selected from a planar surface, a curved surface, a combination of planar and curved surfaces, or a surface provided with an optical microstructure, and each of the two or more incident reflective surfaces is selected from a planar surface, a curved surface, a combination of planar and curved surfaces, and a surface provided with an optical microstructure.

6. The light-guiding element according to claim 1, wherein the mixing light section includes at least one corner portion disposed at a position distal away from the incident light section, and the light modulation section is connected to the at least one corner portion; and
wherein the mixing light section guides the light toward the light modulation section via the at least one corner portion.

7. The light-guiding element according to claim 6, wherein the mixing light section further includes at least one of a straight portion and a curved portion and the mixing light section is disposed between the incident light section and the at least one corner portion.

8. The light-guiding element according to claim 1, wherein at least one light-mixing microstructure region is provided on the two or more mixing reflective surfaces of the mixing light section, and the at least one light-mixing microstructure region is selected from at least one of a micro-prism array, a lenticular lens array, a microlens array, and a texture.

9. The light-guiding element according to claim 1, wherein the emitting section is vertically arranged and perpendicular to a horizontal reference plane, and an angle between the light modulation surface and the horizontal reference plane is less than 60 degrees.

10. The light-guiding element according to claim 1, wherein the light modulation section further includes a light modulation structure disposed on the light modulation surface.

11. The light-guiding element according to claim 10, wherein the light modulation structure is arranged with a uniform density or a non-uniform density.

12. The light-guiding element according to claim 1, wherein the emitting section includes two emitting reflective surfaces respectively located at two sides of the emitting surface, each of the two emitting reflective surfaces is a planar surface, a curved surface, or a combination of planar and curved surfaces, the emitting surface is a planar surface or a textured surface, and a light transmissive material is coated on the emitting surface.

13. The light-guiding element according to claim 1, wherein the emitting section includes two emitting reflective surfaces respectively located at two sides of the emitting surface, and each of the two emitting reflective surfaces is a wavy curved surface extending along a length direction of the light-guiding element.

14. The light-guiding element according to claim 1, wherein the emitting section includes two end portions and an intermediate portion along a length direction of the light-guiding element, and a width of each of the two end portions is less than or equal to a width of the intermediate portion.

15. The light-guiding element according to claim 1, wherein along a length direction of the light-guiding element, the light-guiding element is a linear plate-like element or a curved plate-like element including one or more bending structures.

16. The light-guiding element according to claim 1, wherein the light-guiding element is made of a transparent material with a refractive index greater than 1, the material is selected from polycarbonate, polymethyl methacrylate, silicone, or glass.

17. A light-guiding module, comprising:
a light source configured to provide a light; and
a light-guiding element comprising:
an incident light section including an incident side and two or more incident reflective surfaces, wherein the two or more incident reflective surfaces are arranged around the incident side;
a mixing light section connected to the incident light section and including two or more mixing reflective surfaces, wherein the two or more mixing reflective surfaces are connected to the two or more incident reflective surfaces correspondingly;
a light modulation section connected to the mixing light section and including a light modulation surface; and
an emitting section connected to the light modulation section and including an emitting surface, wherein the emitting surface is configured to face the light modulation surface;
wherein, the light provided by the light source enters the incident side, the two or more incident reflective surfaces reflect the light toward the mixing light section, the two or more mixing reflective surfaces reflect the light toward the light modulation section, the light modulation surface directs the light into the emitting section, and the light emits from the emitting surface.

18. The light-guiding module according to claim 17, wherein the light source is an LED light board including at least one set of LED light-emitting components, and the at least one set of LED light-emitting components is front-emitting and controlled by a circuit.

19. The light-guiding module according to claim 18, wherein the incident light section further includes a plurality of incident cavities spaced apart from each other, each of the plurality of incident cavities is recessed toward an interior of the light-guiding element to define an incident surface with a curved shape, and LEDs of the at least one set of LED light-emitting components are accommodated within corresponding ones of the plurality of incident cavities and faces toward the incident surface.

20. An electronic device, comprising:
a housing including a display region; and
a light-guiding module mounted within the housing and comprising:
a light source configured to provide a light; and
a light-guiding element comprising:
an incident light section including an incident side and two or more incident reflective surfaces, wherein the two or more incident reflective surfaces are arranged around the incident side;
a mixing light section connected to the incident light section and including two or more mixing reflective surfaces, wherein the two or more mixing reflective surfaces are connected to the two or more incident reflective surfaces correspondingly;
a light modulation section connected to the mixing light section and including a light modulation surface; and
an emitting section connected to the light modulation section and including an emitting surface, wherein the emitting surface is configured to face the light modulation surface and is located in the display region;
wherein, the light provided by the light source enters the incident side, the two or more incident reflective surfaces reflect the light toward the mixing light section, the two or more mixing reflective surfaces reflect the light toward the light modulation section, the light modulation surface directs the light into the emitting section, and the light emits from the emitting surface;
wherein the display region is a strip-shaped opening, and the emitting surface of the emitting section is exposed through the display region, and the light source of the light-guiding module is disposed within the housing and is located within a conical field of view deviating by 30 degrees from a vertical centerline of the display region.
